(19) United States
(12) Patent Application Publication
(10) Pub. No.: US 2004/0207613 A1
(43) Pub. Date: Oct. 21, 2004

(54) Information processing apparatus and brightness adjustment method for display device

(75) Inventor: Toshikazu Morisawa, Tokorozawa-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/797,566

(22) Filed: Mar. 11, 2004

(30) Foreign Application Priority Data
Mar. 11, 2003 (JP) 2003-064988

(51) Int. Cl. G03B 21/20; G09G 5/00

(52) U.S. Cl. 345/207

(57) ABSTRACT

An information processing apparatus comprises a display device capable of changing a display brightness, a unit which detects a peripheral illuminance of the display device, a unit which sets the display brightness of the display device in accordance with the detected illuminance, a unit which corrects the set display brightness, and a unit which changes a brightness correction amount corrected in accordance with the detected illuminance.

### CROSS-REFERENCE TO RELATED APPLICATIONS

This application is based upon and claims the benefit of priority from prior Japanese Patent Application No. 2003-064988, filed Mar. 11, 2003, the entire contents of which are incorporated herein by reference.

### BACKGROUND OF THE INVENTION

1. Field of the Invention

The present invention relates to an information processing apparatus having a display device capable of controlling the display brightness and a brightness adjustment method for the display device.

2. Description of the Background Art

Some information processing apparatuses having display devices (e.g., LCD) capable of controlling the display brightness comprise an automatic brightness adjustment mechanism which automatically adjusts the backlight of the LCD to optimal brightness in accordance with the peripheral illuminance (see, e.g., Jpn. Pat. Appln. KOKAI Publication No. 2001-60080). Of information processing apparatuses having no automatic brightness adjustment mechanism, some apparatuses comprise a manual brightness adjustment mechanism which adjusts the backlight of the LCD by predetermined key operation.

Of these information processing apparatuses, apparatuses having the automatic brightness adjustment mechanism are convenient in normal use because the display brightness is automatically adjusted in accordance with the peripheral brightness in normal use. However, the display brightness change amount to the peripheral brightness (illuminance) cannot be arbitrarily set in accordance with the display form or use form of display information or an application program, user's taste, and the like. Apparatuses having the manual brightness adjustment mechanism are inconvenient because the display brightness must be manually adjusted to optimal brightness in normal use in accordance with the use environment such as the peripheral brightness every time the apparatus is used.

As described above, conventional information processing apparatuses having display devices capable of controlling the display brightness are inconvenient in terms of their brightness adjustment mechanism.

### BRIEF SUMMARY OF THE INVENTION

An aspect of the present invention is to provide an information processing apparatus having a convenient brightness adjustment mechanism with high operability and functionality, and a brightness adjustment method for a display device.

An information processing apparatus according to the first aspect of the present invention is characterized by comprising: a display device capable of changing a display brightness; means for detecting a peripheral illuminance of the display device; means for setting the display brightness of the display device in accordance with the detected illuminance; means for correcting the set display brightness; and means for changing a brightness correction amount corrected in accordance with the detected illuminance.

An information processing apparatus according to the second aspect of the present invention is characterized by comprising: a display device capable of changing a display brightness; means for detecting a peripheral illuminance of the display device; means for setting the display brightness of the display device in accordance with the illuminance detected by the illuminance means for detecting; means for changing the display brightness within a predetermined brightness range using the set display brightness as a reference; and means for determining the predetermined brightness range changed by the means for changing in accordance with the detected illuminance.

An information processing apparatus according to the third aspect of the present invention is characterized by comprising: a display device capable of changing a display brightness; means for detecting a peripheral illuminance of the display device; means for setting the display brightness of the display device in accordance with the illuminance detected by the illuminance means for detecting; means for changing the display brightness with a predetermined brightness width using the set display brightness as a reference; and means for determining the predetermined brightness width changed by the means for changing in accordance with the detected illuminance.

A brightness adjustment method for a display device capable of changing a display brightness, according to the fourth aspect of the present invention is characterized by comprising: acquiring a peripheral illuminance of the display device; setting the display brightness of the display device in accordance with the acquired illuminance; correcting the set display brightness; and changing a brightness correction amount corrected in accordance with the acquired illuminance.

A brightness adjustment method for a display device capable of changing a display brightness, according to the fifth aspect of the present invention is characterized by comprising: acquiring a peripheral illuminance of the display device; setting the display brightness of the display device in accordance with the acquired illuminance; changing the display brightness within a predetermined brightness range using the set display brightness as a reference; and determining the predetermined brightness range changed in accordance with the acquired illuminance.

A brightness adjustment method for a display device capable of changing a display brightness, according to the sixth aspect of the present invention is characterized by comprising: acquiring a peripheral illuminance of the display device; setting the display brightness of the display device in accordance with the acquired illuminance; changing the display brightness with a predetermined brightness width using the set display brightness as a reference; and determining the predetermined brightness width changed in accordance with the acquired illuminance.

### BRIEF DESCRIPTION OF THE SEVERAL VIEWS OF THE DRAWING

FIG. 1 is a block diagram showing the configuration of an information processing apparatus according to each embodiment of the present invention;

FIG. 2 is a block diagram showing the configuration of the main part according to each embodiment of the present invention;

FIG. 3 is a perspective view showing an example of the outer appearance of the information processing apparatus according to each embodiment and an example of a key layout used to control the brightness;

FIG. 4 is a graph showing an example of a display brightness setting pattern stored in an illuminance-to-brightness conversion table according to the first embodiment of the present invention;

FIG. 5 is a flow chart showing a processing sequence according to the first embodiment of the present invention;

FIG. 6 is a flow chart showing a processing sequence according to the second embodiment of the present invention;

FIG. 7 is a view showing an example of a GUI window for setting the correction display brightness according to the third embodiment of the present invention; and

FIG. 8 is a graph showing an example of a display brightness setting pattern according to the fourth embodiment of the present invention.

### DETAILED DESCRIPTION OF THE INVENTION

Preferred embodiments of the present invention will be described below with reference to the several views of the accompanying drawing.

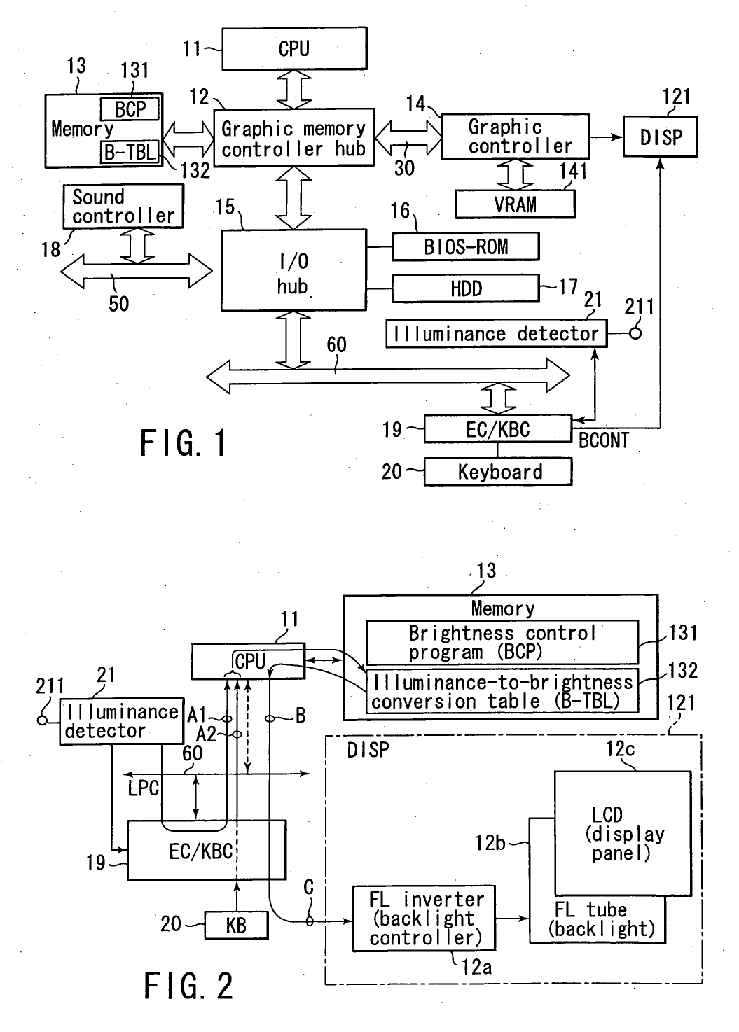

FIG. 1 shows the configuration of an information processing apparatus according to an embodiment of the present invention. A battery-driven notebook type portable personal computer will be exemplified, and the configuration of its computer system is shown.

As shown in FIG. 1, the computer system comprises a CPU 11, graphic memory controller hub 12, memory (main memory) 13, graphics controller 14, VRAM 141, I/O hub 15, BIOS-ROM 16, hard disk drive (HDD) 17, sound controller 18, keyboard/embedded controller (EC/KBC) 19, keyboard 20, illuminance detector 21, and display device (DISP) 121.

The CPU 11 controls the operation of the computer. The CPU 11 executes various processes in accordance with an operating system (OS), application program, utility program, and the like loaded from the hard disk drive 17 to the main memory 13. In the embodiment, the CPU 11 executes display brightness adjustment and display brightness correction (to be described later) in accordance with a brightness control program (BCP) 131. The CPU 11 receives an instruction command by key operation of the keyboard 20 from the keyboard/embedded controller (EC/KBC) 19, and executes processing based on the instruction command.

The memory 13 stores the brightness control program (BCP) 131 and an illuminance-to-brightness conversion table (B-TBL) 132. The brightness control program (BCP) 131 adjusts the display brightness of the display device (DISP) 121 in accordance with the illuminance detected by the illuminance detector 21 by using the illuminance-to-brightness conversion table (132). The illuminance-to-brightness conversion table (B-TBL) 132 may be realized by an arithmetic expression using numerical parameters. The illuminance-to-brightness conversion table (B-TBL) 132 is managed by the brightness control program (BCP) 131. A brightness conversion characteristic representing the relationship between the illuminance and the display brightness is set in advance in the illuminance-to-brightness conversion table (B-TBL) 132. The brightness conversion characteristic set in the illuminance-to-brightness conversion table (B-TBL) 132 will be referred to as a brightness setting pattern. The illuminance-to-brightness conversion table (B-TBL) 132 stores a default brightness setting pattern in activating the system. In the embodiment, the default brightness setting pattern will be referred to as a predetermined (standard) brightness setting pattern. The brightness setting pattern stored in the illuminance-to-brightness conversion table (B-TBL) 132 can be changed within a predetermined brightness correction range using a user interface under the control of the brightness control program (BCP) 131. The processing of the brightness control program (BCP) 131 at this time will be described later.

The graphics controller 14 controls display and driving of the display device 121 under the control of an operating system (OS) executed by the CPU 11. Also, the graphics controller 14 controls display and driving of an external display device via various external display connection interfaces such as a CRT terminal, DVI terminal, and TV terminal (none are shown).

The illuminance detector 21 comprises an illuminance sensor 211. The illuminance detector 21 detects the brightness in the use environment of the computer, i.e., the illuminance around the apparatus, and sends the detection data to the keyboard/embedded controller 19.

The keyboard/embedded controller 19 acquires illuminance detection data from the illuminance detector 21 under the control of the brightness control program (BCP) 131 executed by the CPU 11, and sends the acquired illuminance detection data to the CPU 11. In addition, the keyboard/embedded controller (EC/KBC) 19 sets automatic brightness adjustment data received from the CPU 11 to the brightness controller (backlight controller) of the display device 121. At this time, the CPU 11 adjusts the display brightness of the display device (DISP) 121 in accordance with the illuminance detected by the illuminance detector 21 by using the illuminance-to-brightness conversion table (B-TBL) 132 in accordance with the brightness control program (BCP) 131. When key operation of correcting the display brightness of the display device 121 is done via the keyboard 20, the keyboard/embedded controller (EC) 19 sends the correction instruction to the CPU 11 under the control of the brightness control program (BCP) 131 executed by the CPU 11. The CPU 11 changes the brightness setting pattern of the illuminance-to-brightness conversion table (B-TBL) 132 in accordance with the display brightness correction instruction received from the keyboard/embedded controller 19. After that, the CPU 11 adjusts the display brightness of the display device (DISP) 121 in accordance with the illuminance detected by the illuminance detector 21 by using the changed brightness setting pattern in the illuminance-to-brightness conversion table (B-TBL) 132. These processes will be explained later.

FIG. 2 shows the configuration of the main part of the computer system according to the embodiment.

As shown in FIG. 2, the display device 121 comprises an LCD (Liquid Crystal Display) 12c used as a display panel, an FL tube 12b used as the backlight of the display panel, and a brightness controller 12a having an FL inverter which controls the illuminance of the backlight, i.e., the brightness of the display screen.

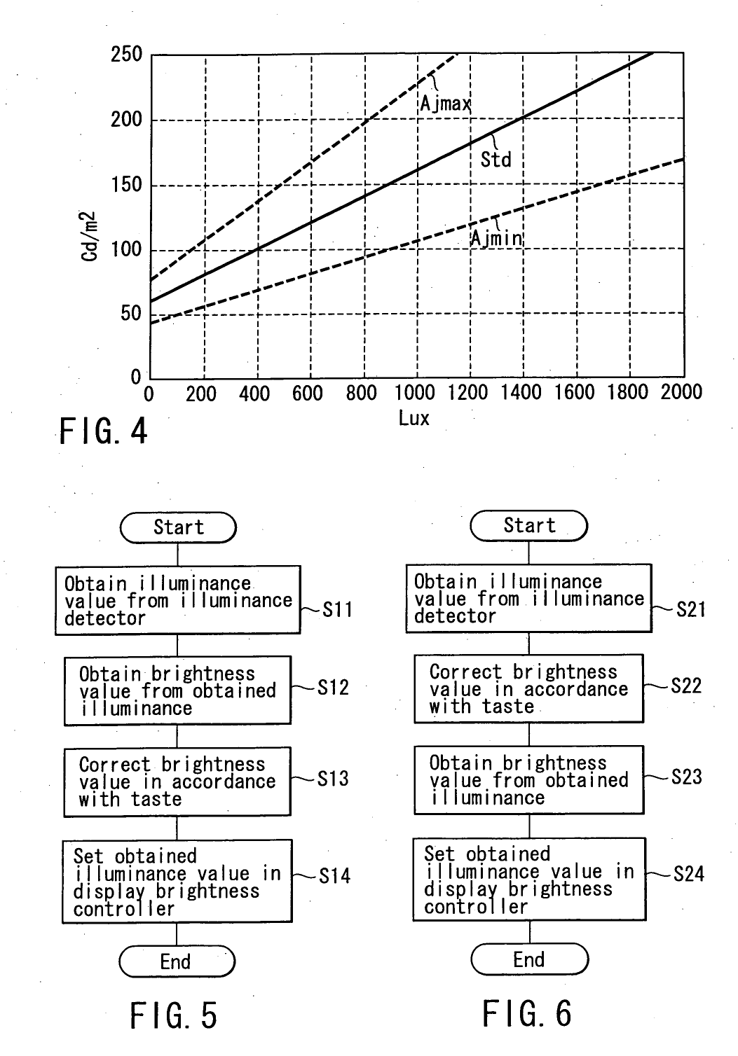

The CPU 11 executes brightness adjustment processing based on the brightness control program (BCP) 131 stored in the memory 13. This processing sequence is shown in the flow chart of FIG. 5 or 6 (to be described later). In brightness adjustment processing, the CPU 11 adjusts the display brightness of the display device (DISP) 121 in accordance with the illuminance detected by the illuminance detector 21 by using the illuminance-to-brightness conversion table (B-TBL) 132 in accordance with the brightness control program (BCP) 131 stored in the memory 13. In an initial state after activating the system, a predetermined (standard) brightness setting pattern (see Std in FIG. 4) is stored in the illuminance-to-brightness conversion table (B-TBL) 132. Using this standard brightness setting pattern, the CPU 11 adjusts the display brightness of the display device (DISP) 121 in accordance with the illuminance detected by the illuminance detector 21. At this time, the brightness controller 12a of the display device (DISP) 121 controls the emission amount of the FL tube 12b in accordance with the illuminance detected by the illuminance detector 21. This processing flow is represented by A1→B→C in FIG. 2. When key operation of correcting the display brightness of the display device 121 is done via the keyboard 20, the CPU 11 receives the display brightness correction instruction from the keyboard/embedded controller 19. The CPU 11 corrects the contents (brightness setting pattern) of the illuminance-to-brightness conversion table (B-TBL) 132 in accordance with the instruction. Thereafter, the CPU 11 adjusts the display brightness of the display device (DISP) 121 in accordance with the illuminance detected by the illuminance detector 21 by using the corrected brightness setting pattern. This processing flow is represented by A1·A2→B→C in FIG. 2.

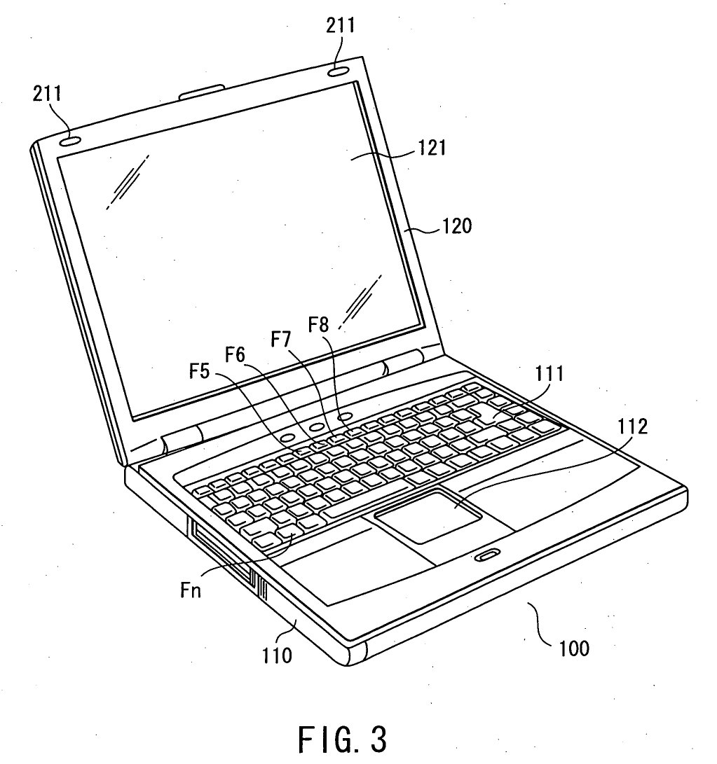

FIG. 3 shows the outer appearance of the computer according to the embodiment and an example of a key layout used to correct the display brightness. FIG. 3 illustrates a notebook type personal computer. A computer 100 shown in FIG. 3 according to the embodiment of the present invention is comprised of a computer main body 110 and display unit (display unit housing) 120. The display unit 120 incorporates a display device using an LCD as the display device 121. The display unit 120 which incorporates the display device 121 is attached to the computer main body 110 so as to be pivotable between an open position and a closed position. The display unit 120 has the illuminance sensor 211 which detects the peripheral brightness.

The computer main body 110 has a thin box-like housing. The keyboard 20 is arranged on the upper surface of the housing, and an armrest is formed on the upper surface of the housing in front of the keyboard 20. A touch panel 112 is arranged at almost the center of the armrest. The keyboard 20 has operation keys for correcting the display brightness of the display device 121 by automatic display brightness adjustment. In the first embodiment of the present invention, stepwise brightness-up setting corresponding to the press count of an “F6” key is done by pressing the “F6” key while pressing an “Fn” key. Stepwise brightness-down setting corresponding to the press count of an “F7” key is done by pressing the “F7” key while pressing the “Fn” key. This stepwise brightness-up/down setting is performed within a range of four steps (± eight steps).

FIG. 4 shows an example of the display brightness setting pattern stored in the illuminance-to-brightness conversion table (B-TBL) 132. In FIG. 4, the abscissa represents an illuminance (Lux) detected by the illuminance sensor 211 of the illuminance detector 21, and the ordinate represents the display brightness (Cd/m²) of the display device (DISP) 121. FIG. 4 exemplifies a brightness correction characteristic in which the display brightness change amount increases as the illuminance increases. For the standard brightness setting pattern (Std) set as a default display brightness characteristic, eight correction brightness setting patterns are prepared in each of a direction in which the display brightness is increased (up), and a direction in which the display brightness is decreased (down). (Ajmax) represents an upper limit brightness setting pattern in the direction in which the display brightness is increased (up), and (Ajmin) represents a lower limit brightness setting pattern in the direction in which the display brightness is decreased (down). The range between these two patterns is set as a brightness range. For example, the display brightness change amount (brightness width) per step is about ±4 Cd/m² for an illuminance of 400 Lux, and about ±6 Cd/m² for an illuminance of 800 Lux. When the illuminance detected by the illuminance detector 21 is 400 Lux, the display brightness of the display device (DISP) 121 is increased by about 4 candela (Cd/m²) from the display brightness in initial operation based on the standard brightness setting pattern (Std) by pressing the “F6” key once on the keyboard 20 while pressing the “Fn” key. The display brightness of the display device (DISP) 121 is decreased by about 4 candela (Cd/m²) from the initial display brightness based on the standard brightness setting pattern (Std) by pressing the “F7” key once while pressing the “Fn” key. While the “Fn” key is pressed, the “F6” or “F7” key is pressed an arbitrary number of times limited to eight, canceling the press of the “Fn” key. Accordingly, the keyboard/embedded controller 19 notifies the CPU 11 of a correction brightness setting pattern selected by “F6” or “F7” key operation. The CPU 11 corrects the display brightness stored in the illuminance-to-brightness conversion table (B-TBL) 132 in accordance with the correction brightness setting pattern received from the keyboard/embedded controller 19.

FIG. 5 shows a processing sequence according to the first embodiment of the present invention. This processing is realized when the CPU 11 executes the processing of the brightness control program (BCP) 131. An illuminance value detected by the illuminance sensor 211 of the illuminance detector 21 is loaded to the CPU 11 via the keyboard/embedded controller 19 (step S11: see A1 in FIG. 2). By using the illuminance-to-brightness conversion table (B-TBL) 132, the CPU 11 acquires the display brightness value of the display device (DISP) 121 to the illuminance detected by the illuminance sensor 211 (step S12). The CPU 11 sends the acquired display brightness value to the display device (DISP) 121 via the keyboard/embedded controller 19 (see B and C in FIG. 2). In the display device (DISP) 121, when the brightness controller 12a receives the display brightness value, the brightness controller 12a adjusts the emission amount of the FL tube 12b (i.e., the brightness on the display screen of the LCD 12c) in accordance with the value.

If key operation of correcting the display brightness of the display device 121 is performed by predetermined key operation via the keyboard 20, the CPU 11 is notified via the keyboard/embedded controller (EC) 19 of a display brightness correction instruction along with this key operation. Upon reception of the display brightness correction instruction from the keyboard/embedded controller 19, the CPU 11 corrects the brightness setting pattern stored in the illuminance-to-brightness conversion table (B-TBL) 132 in accordance with the instruction (step S13). After that, the CPU 11 adjusts the display brightness of the display device (DISP) 121 in accordance with the illuminance value acquired by the illuminance detector 21 by using the corrected brightness setting pattern. Detailed brightness value correction operation and accompanying correction processing have already been described, and a description thereof will be omitted.

In this manner, the user can easily set a desired brightness change amount upon a change in illuminance in accordance with the type of executed application, the display contents, the use environment, the use purpose, user's taste, and the like.

FIG. 6 shows a processing sequence according to the second embodiment of the present invention. The second embodiment is especially different from the processing sequence of the first embodiment shown in FIG. 5 in that the display brightness is corrected for a brightness value obtained from the illuminance (steps S11 to S13 in FIG. 5), whereas an illuminance detected by an illuminance detector 21 is corrected in the second embodiment (steps S21 to S24 in FIG. 6). Similar to the first embodiment, this correction operation can also be performed using an “Fn” key, “F6” key, and “F7” key on a keyboard 20. Also in the second embodiment, the display brightness of a display device (DISP) 121 is finally corrected for the illuminance detected by the illuminance detector 21.

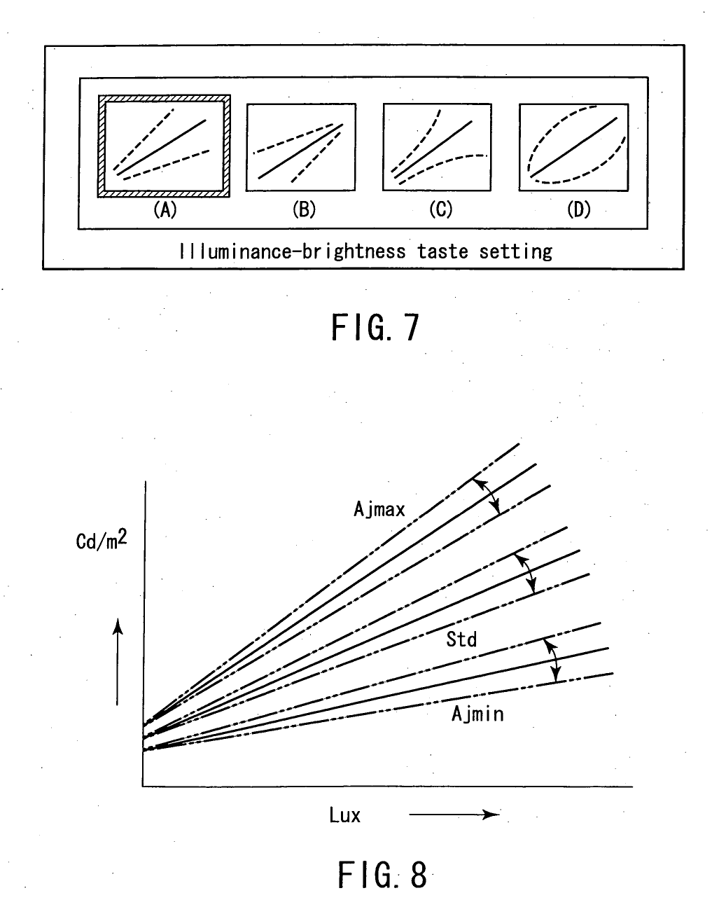

FIG. 7 shows an example of a GUI window for setting the correction display brightness according to the third embodiment of the present invention. In the third embodiment, a plurality of types (a plurality of sets) of display brightness setting patterns as shown in FIG. 4 are prepared by changing the display brightness conversion characteristic of the correction display brightness setting pattern. When a display brightness correction request is received, the GUI window as shown in FIG. 7 is displayed on a display device (DISP) 121. An arbitrary pattern type is selected from the plurality of correction display brightness setting pattern types prepared in advance. One correction display brightness setting pattern is selected from the selected correction display brightness setting pattern type, similar to the first embodiment. In the example of FIG. 7, a setting window providing graphs of four pattern types (“A” to “D”) including the pattern type shown in FIG. 4 are displayed on the display device (DISP) 121. Pattern types to be selected every time the “F5” key is pressed once while the “Fn” key is pressed are sequentially switched on the setting window using, e.g., the “Fn” key and “F5” key on a keyboard 20 shown in FIG. 3. One pattern type can be-selected by canceling “Fn” key operation while selecting a desired pattern type. One correction display brightness setting pattern is selected from the selected pattern type using the “Fn” key, “F6” key, and “F7” key. The selection function for the correction display brightness setting pattern can further widen the display brightness correction range depending on user's taste and the like.

FIG. 8 is a graph showing an example of a display brightness setting pattern according to the fourth embodiment of the present invention. In the display brightness setting pattern shown in FIG. 4 according to the first embodiment, the display brightness setting pattern (Std) is fixed. To the contrary, in the fourth embodiment, the standard brightness setting pattern (Std) can be finely adjusted in accordance with user's taste and the like. Fine adjustment of the standard brightness setting pattern (Std) can be realized not only by software control, but also by hardware control of adjusting, e.g., a sensor output (sensor sensitivity) from an illuminance sensor 211 by volume operation or the like. In the fourth embodiment, the upper limit correction brightness setting pattern (Ajmax) and lower limit correction brightness setting pattern (Ajmin) also vary in accordance with the adjustment amount of the standard brightness setting pattern (Std). The fine adjustment function for the standard brightness setting pattern (Std) can further widen user's taste for the display brightness.

Correction operation and accompanying operation in the second to fourth embodiments can be easily realized by the first embodiment, and a detailed description thereof will be omitted.

According to the embodiments of the present invention, the user can easily set a desired brightness change amount upon a change in illuminance in accordance with the type of executed application, the display contents, the use environment, the use purpose, user's taste, and the like. An optimal display brightness desired by the user can be easily set in automatic display brightness control in a mobile computer or the like.

Hence, an information processing apparatus having a convenient brightness adjustment mechanism with high operability and functionality can be provided.

Additional advantages and modifications will readily occur to those skilled in the art. Therefore, the present invention in its broader aspects is not limited to the specific details, representative devices, and illustrated examples shown and described herein. Accordingly, various modifications may be made without departing from the spirit or scope of the general inventive concept as defined by the appended claims and their equivalents.

What is claimed is:

1. An information processing apparatus comprising:
a display device capable of changing a display brightness;
means for detecting a peripheral illuminance of the display device;
means for setting the display brightness of the display device in accordance with the detected illuminance;
means for correcting the set display brightness; and
means for changing a brightness correction amount corrected in accordance with the detected illuminance.

2. An apparatus according to claim 1, wherein the means for setting the display brightness determines the brightness of the display device on the basis of a predetermined brightness setting pattern which defines a brightness change amount in a change of illuminance, and sets the display brightness of the display device in accordance with the illuminance detected by the means for detecting the illuminance.

3. An apparatus according to claim 2, wherein the means for changing the correction amount comprises correction brightness setting patterns in which the brightness change amount to the change in illuminance is changed stepwise from the predetermined brightness setting pattern at a predetermined ratio, and means for selecting one of the correction brightness setting patterns, and the means for correcting corrects a variable brightness amount to the change in illumination by means for adjusting the display brightness in accordance with the brightness change amount to the change in illuminance that is defined in the selected correction brightness setting pattern.

4. An apparatus according to claim 3, wherein the means for setting the display brightness has a plurality of sets of correction brightness setting patterns for respective brightness conversion characteristics, and the means for selecting further comprises a graphic user interface which is displayed on the display device so as to be able to select each of the plurality of sets of correction brightness setting patterns prepared in the means for setting.

5. An apparatus according to claim 4, wherein the graphic user interface displays a graph of each set of correction brightness setting patterns to be selected by the means for selecting, so as to be able to select each set.

6. An apparatus according to claim 5, wherein the means for selecting includes means for performing, by predetermined key input operation, selection of the set of correction brightness setting patterns and selection of a correction brightness setting pattern in the selected set.

7. An information processing apparatus comprising:
a display device capable of changing a display brightness;
means for detecting a peripheral illuminance of the display device;
means for setting the display brightness of the display device in accordance with the illuminance detected by the illuminance means for detecting;
means for changing the display brightness within a predetermined brightness range using the set display brightness as a reference; and
means for determining the predetermined brightness range changed by the means for changing in accordance with the detected illuminance.

8. An apparatus according to claim 7, further comprising
means for storing a plurality of correction patterns which define the predetermined brightness range,
means for selecting a correction pattern from the plurality of patterns, wherein
the means for determining the predetermined brightness range determines the predetermined brightness range in accordance with the correction pattern selected by the means for selecting and the illuminance detected by the means for detecting.

9. An apparatus according to claim 7, wherein the means for changing can change the brightness stepwise with a predetermined change width within the predetermined brightness range.

10. An apparatus according to claim 9, wherein the predetermined change width is changed in accordance with the illuminance.

11. An information processing apparatus comprising:
a display device capable of changing a display brightness;
means for detecting a peripheral illuminance of the display device;
means for setting the display brightness of the display device in accordance with the illuminance detected by the illuminance means for detecting;
means for changing the display brightness with a predetermined brightness width using the set display brightness as a reference; and
means for determining the predetermined brightness width changed by the means for changing in accordance with the detected illuminance.

12. A brightness adjustment method for a display device capable of changing a display brightness, comprising:
acquiring a peripheral illuminance of the display device;
setting the display brightness of the display device in accordance with the acquired illuminance;
correcting the set display brightness; and
changing a brightness correction amount corrected in accordance with the acquired illuminance.

13. A brightness adjustment method for a display device capable of changing a display brightness, comprising:
acquiring a peripheral illuminance of the display device;
setting the display brightness of the display device in accordance with the acquired illuminance;
changing the display brightness within a predetermined brightness range using the set display brightness as a reference; and
determining the predetermined brightness range changed in accordance with the acquired illuminance.

14. A brightness adjustment method for a display device capable of changing a display brightness, comprising:
acquiring a peripheral illuminance of the display device;
setting the display brightness of the display device in accordance with the acquired illuminance;
changing the display brightness with a predetermined brightness width using the set display brightness as a reference; and
determining the predetermined brightness width changed in accordance with the acquired illuminance.
